(19) United States
(12) Patent Application Publication
(10) Pub. No.: US 2026/0271902 A1
(43) Pub. Date: Sep. 17, 2026

(54) FISHING ACCESSORY APPARATUS FOR USE WITH A CIRCULAR TROLLING DIVER

(71) Applicant: Kyle L. DenBoer, Hudsonville, MI (US)

(72) Inventor: Kyle L. DenBoer, Hudsonville, MI (US)

(21) Appl. No.: 19/668,647

(22) Filed: May 5, 2026

(51) Int. Cl. A01K 89/015; A01K 89/0165

(52) U.S. Cl. CPC A01K 89/01931; A01K 89/0165

(57) ABSTRACT

A fishing accessory apparatus or keeper that neatly stows circular fishing tackle devices such as divers along with their associated fishing line lengths and accessories. The tackle device or diver is slid by the user into a slot formed within the keeper where the associated forward and main fishing line is wrapped around the outer wall of the keeper. The fishing line is woven by the user between ergonomic protrusions with the option of further securing the line using an elastic band. Thus, the keeper includes geometric features that allow the diver and its associated line to wrap along and around its housing. Since the transition between storage and deployment is easily accomplished, the keeper allows the user a more pleasurable fishing experience.

### FIELD OF THE INVENTION

The present invention relates generally to fishing tackle and more particularly to an accessory apparatus for fishing line management, containment and holding of a diver and fishing line.

### BACKGROUND

Fisherman often use many different types of fishing tackle depending on the situation. One of these types of tackle is “dipsy diver”. The dipsy diver or “diver” is a trolling device used in fishing sports. The diver controls the bait/lure by positioning the leader down at a specific depth in the water while trolling while also keeping it out to the side of the boat. The diver is widely used for species like salmon, lake trout, and walleye, especially in the Great Lakes region. The diver is essentially a weighted, hydrodynamic disk with an adjustable base plate. When trolling, water pressure forces the diver downward, forcing the lure deeper in the water. An adjustable directional weight allows the fisherman to set the diver so to pull left or right, spreading fishing lines away from the boat. When a fish strikes the lure, a release mechanism trips, causing the diver to stop its diving force so the fisherman can fight the fish without heavy resistance.

Although many types of tackle have their own storage, the dipsy diver is problematic for storage because of its leader and the various line lengths. Since it uses a substantially long leader line attached to the diver, when it is incorrectly stored, this causes several problems. Anglers have attempted to use pool noodles to wrap line or wrapping the leader around the diver. These types of solutions have their own problems since the leader can be easily cut or kinked, causing weak areas and subsequent line breakage. The leader can also become tangled to the point the fisherman has to cut the line and retie the diver. These problems can also be expensive especially in situations where multiple divers are deployed in charter boat situations. The fisherman has to then struggle with tangled lines, bad leaders, as well as broken equipment that costs time, money, and lost fish. Consequently, new storage solutions are required to address these issues.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A is a perspective view illustrating a top side and right side of the keeper for a circular trolling diver in accordance with an embodiment of the invention.

FIG. 1B is a perspective view illustrating a top side and left inside portion of the keeper shown in FIG. 1A.

FIG. 1C is a perspective view illustrating a bottom of the keeper shown in FIG. 1A.

FIG. 2 is an exploded view illustrating how a diver is configured to be held within the keeper.

Skilled artisans will appreciate that elements in the figures that are illustrated for simplicity and clarity. Note that the drawings shown are not and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a fishing accessory apparatus used with a circular trolling diver. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

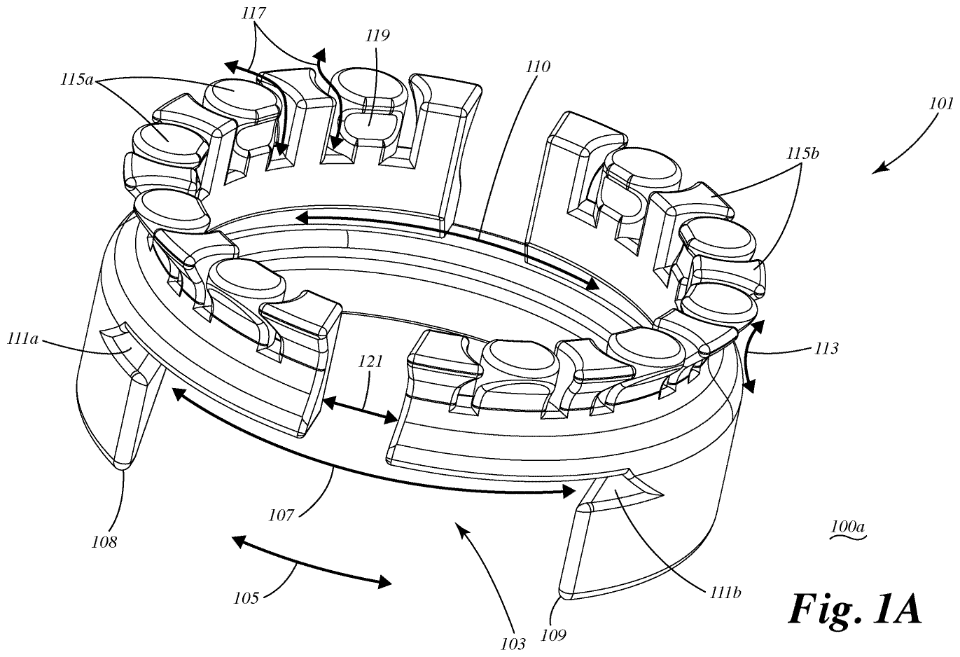

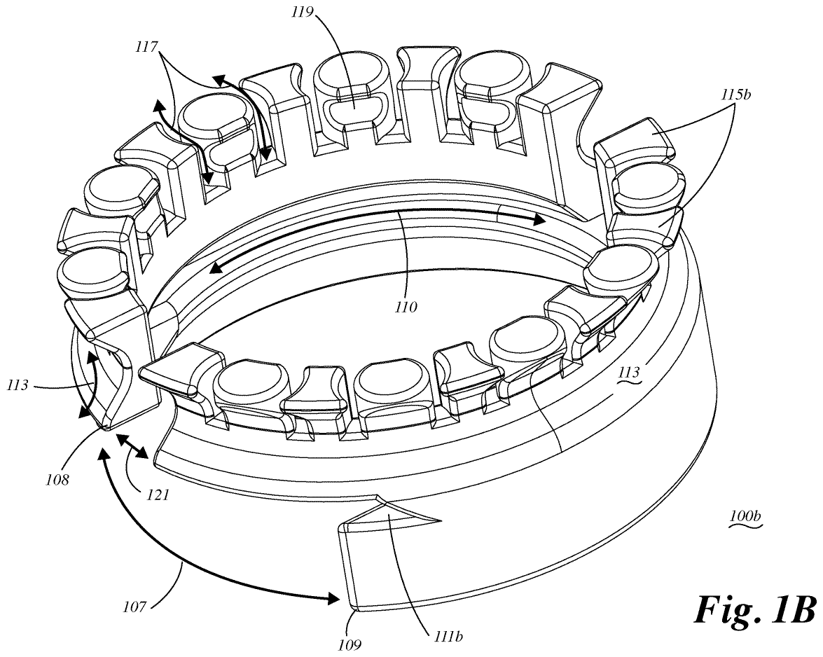

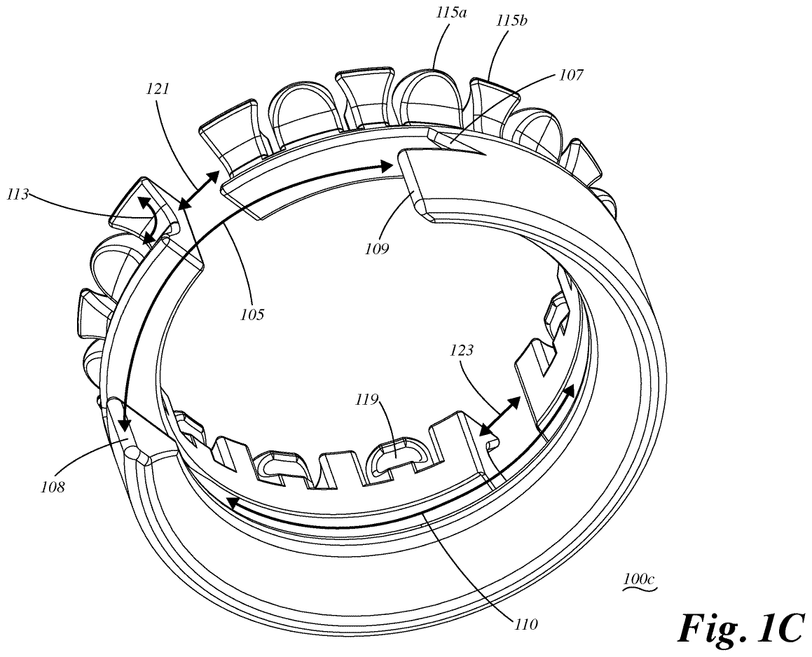

With regard to FIG. 1A to FIG. 1C, the present invention is directed to a fishing accessory apparatus such as “keeper” 100a, 100b, 100c for use with a circular trolling diver which is sometimes called a “sinker” or “planer”. As seen in the figures, the keeper 100a, 100b, 100c has a solid circular body or housing having no separate or moving components. Internally, the housing has a substantially round, semi-hollow shape, allowing space for flexing, bending and/or energy absorption. Thus, those skilled in the art will recognize that the size of keeper 100a, 100b, 100c is adaptable to fit varying diameters and thicknesses of diver e.g. a circular sinker or dipsey type diver. Generally, the size/aspect ratio of the keeper 100a, 100b, 100c is one where its overall height is approximately one-third of its diameter, and thickness are approximately one-third of overall height.

The keeper 100a, 100b, 100c housing has an upper side 101 and lower side 103. The lower side 103 includes an entrance area such as mouth 105 located between walls 108, 109. The mouth 105 is typically sized smaller than the diameter of a diver. Along an upper portion of mouth 105, a receiving region such as retention slot 107 is formed between resilient walls 111a, 111b. The slot 107 is sized to accommodate the diameter of the circular diver. When in use, the diver is inserted within slot 107 where the slot 107 works to frictionally engage with the diver to hold it firmly in a stowed position. Stop surface 110 works to prevent further movement of the diver when inserted in the slot 107.

At a top edge of the lower side 103, a deepened concave groove 113 is configured to span about the perimeter of the keeper housing. As will be evident to those skilled in the art, the groove 113 is used to spool, wind and neatly “keep” fishing line attached to the diver so it can be easily deployed when needed. More specifically, on the outer surface of the housing, a smooth and tapered groove 113 is formed into a concave pocket-like shape. This pocket continues up the remaining outer sidewall of the housing, where its outer contours extend into a plurality of retention posts 115a, 115b. The retention posts 115a,115b configured adjacent one another, lining the circular upper side 101 of the housing. The retention posts 115a, 115b are used to fasten an end of the forward fishing line and/or a retention end extending from the groove 113. The retention posts 115a, 115b are arranged in an alternating circular manner using two differing shapes. More specifically, a first retention post 115a has a truncated convex rounded shape while a second retention post 115b has a truncated square-like shape with tapered concave sides. Both the retention posts 115a, 115b are positioned around the overall circular shape on the upper side 101 of the housing.

Those skilled in the art will further recognize that between the retention posts 115a, 115b are a plurality of gaps 117 that are configured between each adjacent retention posts. The gaps 117 allow forward fishing line to be pushed, slipped, tucked and/or weaved therein to secure the line in position around the keeper 100a, 100b, 100c Thus, the retention posts 115a, 115b have geometric features allowing them to retain fishing line attached to the diver.

At the interior wall of the round retention posts 115a, a groove is cut as a retention pocket 119. The hollow nature of the retention pocket 119 allows it to be used to store auxiliary fixing tools, such as rubber or elastic bands. Since the diver includes a fastening member along its top, the keeper 100a, 100b, 100c includes openings 121, 123 at its upper side 101. Openings 121, 123 are spaced 180-degrees apart on the upper side 101. The openings 121, 123 mirror the location of the fastening member on the diver so to allow the diver to be fully inserted into slot 107 when stored.

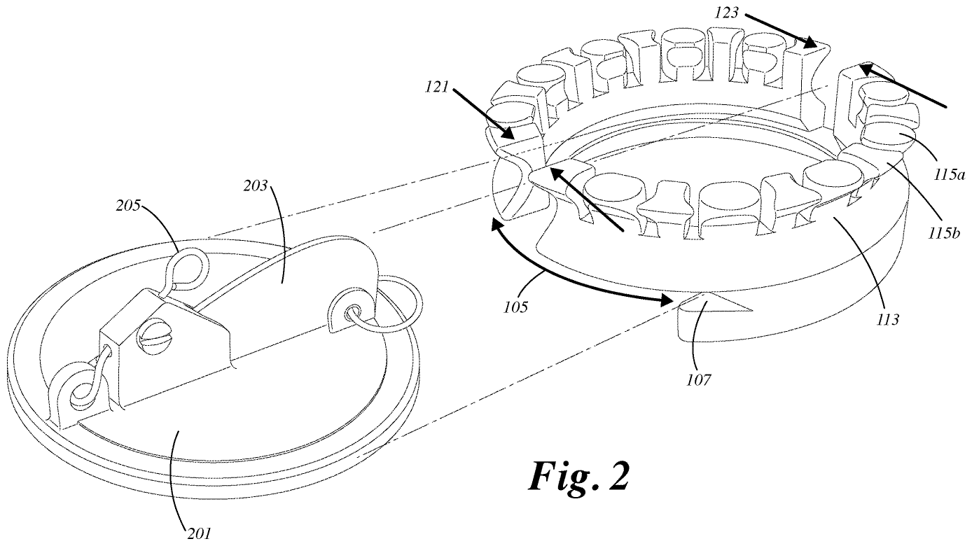

FIG. 2 is an exploded view illustrating how a diver is configured to be held within the keeper. As seen in FIG. 2, the diver 201 has a substantially flat surface 201 where a fastening member 203 extends vertically therefrom. Various loops, hooks or other fasteners 205 connect to the fastening member 203 allowing the diver 201 to be easily fastened to the fishing line. Those skilled in the art will further recognize that the diver 201 is inserted into slot 107 via the mouth 105 with its lateral position securely fixed in the keeper due to the depth and geometry of slot 107. When in use, the open top and bottom of the keeper allow for necessary manipulation of the diver being held therein such as the adjustment of weight, float angle, and/or setup of tackle. Those skilled in the art will further recognize that both a diver bearing line and the main line may be wrapped and/or affixed separately with or without accessory tackle such as snubbers, lures and/or leaders affixed there to. The keeper permits a fisherman to swap tackle easily avoiding disorganization, entanglement, and damage to the line and tackle. For example, the angler or fisherman may keep one or more active rods, enabling them to change target fish species, size, or environment, without the need to keep multiple rods set up on the boat. Thus, the keeper adds convenience by preventing the fishman from having to frequently remove and/or replace their tackle. Moreover, as there are many variations of associated divers that vary in size and weight, according to fishing depth, the fisherman may wish to rotate tackle devices targeting different species or depths. The keeper allows this easy transition between different types of tackle.

Thus, the keeper 100a 100b, 100c includes a circular and flexible frame that encases, maintains, and protects without encumbering the diver 201 when used in kinetic sport fishing. Additionally, the keeper 100a, 100b, 100c allows the angler to spool lengths of fishing line around it. The fishing line is typically wound in one direction toward the active lure that bears the forward line, and in the opposing direction toward the main line and rod assembly. The geometry of the keeper provides a means by which to wrap and fix the lead and lure bearing fishing line, sometimes referred to as a forward line, which is otherwise loose. This arrangement prevents tangling and the potential for injury since an uncontained hook bearing lure is securely held during the use, deployment, recall, transport, or stowing of either fishing rods. The overall configuration of the keeper can be sized uniformly to accommodate different size varieties of inline diver where the dimension of the inner mating slot is adjusted accordingly.

Thus, embodiments of the present invention are directed to a fishing/angling accessory or “keeper” used in connection with a circular trolling diver during trolling or otherwise kinetic line and rod fishing in boat or marine vehicle. The diver utilizes a circular body, togglable weight, and controller for directing the position of the diver's depth within a water column where it can be switched to a free position that is triggered upon attachment of a fish. Thus, the keeper when used with the diver provides an encasement, storage and transport enabling easy deployment of a fishing line attached to the diver. The keeper accepts the rigid angle of the diver disk allowing the keeper to operate with a “planer” or “trolling diver” facilitating an ease and organization of stowage, protection of the diver and its respective lengths of fishing line, and any auxiliary tackle items such as snap swivels, connectors, snubs, leads.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A fishing accessory apparatus comprising:
a substantially circular housing;
wherein the substantially circular housing includes a retention slot and tapered groove for neatly storing a fishing diver and associated fishing line before deployment while trolling.

2. The fishing accessory apparatus as in claim 1, wherein the retention slot comprises at least one resilient wall defining an opening through which the fishing diver is inserted.

3. The fishing accessory apparatus of claim 1, wherein the circular housing includes a tapered groove about its perimeter configured to receive fishing line.

4. The fishing accessory apparatus of claim 3, wherein the tapered groove forms a pocket.

5. The fishing accessory apparatus of claim 1, wherein the circular housing includes at least one retention post extending therefrom for holding an end of fishing line in a fixed position.

6. The fishing accessory apparatus of claim 1, where the at least one retention post is configured in a plurality of shapes.

7. A fishing accessory apparatus comprising:
a keeper body configured to allow fishing line to be wound thereon;
a retention slot formed within the keeper body defining a receiving region sized to receive a fishing diver; and
wherein the retention slot is configured to releasably retain the fishing diver within the receiving region during use and to permit removal of the fishing diver without displacing the fishing line.

8. The fishing accessory apparatus as in claim 7, wherein the retention slot comprises at least one resilient wall defining an opening through which the fishing diver is inserted.

9. The fishing accessory apparatus of claim 8, wherein the at least one resilient wall is elastically deformable to allow snap-fit insertion and removal of the fishing diver.

10. The fishing accessory apparatus of claim 7, wherein the retention slot includes a narrowed entrance to retain the fishing diver.

11. The fishing accessory apparatus of claim 7, wherein the keeper body includes a tapered groove that is configured to receive fishing line.

12. The fishing accessory apparatus of claim 11, wherein the tapered groove forms a pocket.

13. The fishing accessory apparatus of claim 7, wherein the keeper body includes at least one retention post for holding an end of fishing line in a fixed position.

14. The fishing accessory apparatus of claim 7, wherein the retention post is configured in a plurality of shapes.

15. The fishing accessory apparatus of claim 13, wherein the at least one retention post is configured to hold the fishing line in a fixed orientation relative to the keeper body.

16. The fishing accessory apparatus of claim 13, wherein the at least one retention post includes a plurality of alternating retaining posts spaced apart to have gaps therebetween.

17. The fishing accessory apparatus of claim 16, wherein the alternating retaining posts are configured to define a gap wider than a maximum width of fishing line.

18. The fishing accessory apparatus of claim 7, wherein the keeper body further comprises a stop surface configured to limit movement of the fishing diver when once inserted in the retention slot.

19. A fishing accessory apparatus comprising:
a keeper body;
a retention slot formed within the keeper body defining a receiving region sized to receive a fishing diver;
a tapered groove configured about the keeper body for allowing fishing line to be wound thereon;
at least one retention post extending from the keeper body for holding an end of fishing line in a fixed position; and
wherein the retention slot is configured to releasably retain the fishing diver within the receiving region during use and to permit removal of the fishing diver without displacing the fishing line.

20. A fishing accessory apparatus as in claim 19, wherein the at least one retention post includes a plurality of first retaining posts having first shape and a plurality of second retaining posts having a second shape spaced about a perimeter of the keeper body to include gaps therebetween.
